(19) United States
(12) Patent Application Publication
(10) Pub. No.: US 2008/0017168 A1
(43) Pub. Date: Jan. 24, 2008

(54) Engine Event-Based Correction Of Engine Speed Fluctuations

(76) Inventors: Kenneth P DeGroot, Macomb Twp, MI (US); Jeffrey P. Wuttke, Sterling Heights, MI (US); Dennis W. Fett, Clinton Twp., MI (US); Gerald L. Kennie, Marysville, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/458,772

(22) Filed: Jul. 20, 2006

(51) Int. Cl. F02M 7/00

(52) U.S. Cl. 123/436

(57) ABSTRACT

Fuel delivery to a combustion engine may be controlled by determining the roughness of current engine operation, comparing the determined roughness with a control roughness to determine if the determined roughness is within a threshold limit of the control roughness, and changing the fuel delivery to the engine in a subsequent fuel delivery event as a function of the difference between the determined roughness and the control roughness. Preferably, the fuel delivery is changed at least when the determined roughness is not within the threshold limit, although other factors may be taken into account when changing the fuel delivery to the engine.

### FIELD OF THE INVENTION

The present invention relates generally to internal combustion engines and more particularly to correction of engine speed fluctuations.

### BACKGROUND OF THE INVENTION

Automotive vehicles may employ a fuel injected internal combustion engine in which a fuel injector discharges fuel into air in an intake manifold of the engine. The conventional fuel injector typically is controlled and responds to a fuel injection pulse width signal in which the pulse width determines the amount of fuel injected into the corresponding cylinder of the engine. The fuel injection pulse width signal can be implemented to follow a programmed curve or algorithm. A programmed fuel injection curve or algorithm determines the fuel injection pulse width and is generally utilized to provide adequate engine performance when feedback or closed-loop engine control is not available.

Automotive vehicles may employ an oxygen sensor generally disposed upstream of an exhaust system and capable of sensing the oxygen level in the exhaust gas emitted from the engine. The oxygen sensor can provide a feedback signal to control engine operation and adjust fuel injection to the engine. However, at least some oxygen sensors need to warm up to a sufficiently high temperature before an accurate oxygen sensor reading may be obtained. Also, in the period immediately following an engine start, the oxygen sensor and other devices may not have acquired enough information to provide adequate feedback control. Therefore, for a period of time immediately following a cold start up of the vehicle engine, the oxygen sensor may not be capable of providing accurate information with which the engine may be controlled. As a consequence, undesirable hydrocarbon emissions may be emitted from the vehicle within the period immediately following start-up of the engine. Additionally, immediately following a cold engine start, the catalyst of a catalytic converter can be ineffective since the catalyst may require a period of time to warm up to a temperature at which the catalyst can operate effectively. As a consequence, hydrocarbon emissions may be even higher during initial engine operation, especially after a cold start.

### SUMMARY OF THE INVENTION

Fuel delivery to a combustion engine may be controlled by determining the roughness of current engine operation, comparing the determined roughness with a control roughness to determine if the determined roughness is within a threshold limit of the control roughness, and changing the fuel delivery to the engine in a subsequent fuel delivery event as a function of the difference between the determined roughness and the control roughness. Preferably, the fuel delivery is changed at least when the determined roughness is not within the threshold limit, although other factors may be taken into account when changing the fuel delivery to the engine.

In one presently preferred implementation, the fuel delivery change is made as a function of the difference between the determined roughness and the threshold limit. Further, the fuel delivery change may be made for a single subsequent combustion event in the engine. In other words, the fuel delivery change may be made for a fuel delivery event into a single engine cylinder after the determination has been made to change the amount of fuel delivered to the engine for combustion. Thereafter, the roughness of the current engine operation may again be compared to the control roughness to determine if subsequent changes to the fuel delivery are required. In this manner, discrete changes to the rate of fuel delivery to the engine can be made, such as in discrete or individual cylinder combustion events, to bring the engine operation into threshold limits for roughness. Desirably, the fuel delivered to the engine during initial operation after a cold start of the engine can be lower than stoichiometric ratios to control and reduce hydrocarbon emissions from the vehicle.

### BRIEF DESCRIPTION OF THE DRAWINGS

Exemplary embodiments of the present disclosure will become more fully understood from the detailed description and the accompanying drawings, in which:

FIG. 1 is a flow diagram illustrating a method of determining whether change to the rate of fuel delivery to the engine is needed;

FIG. 2 is a graph illustrating, in general fashion, the difference between a stoichiometric fuel curve and a desired fuel curve for initial operation after cold start of an engine;

FIG. 3 is a graph that diagrammatically illustrates a comparison of a desired roughness value with an actual determined roughness value of current engine operation; and

FIG. 4 is a graph that diagrammatically represents a fuel curve including a fuel delivery change event.

### DETAILED DESCRIPTION OF PREFERRED EMBODIMENTS

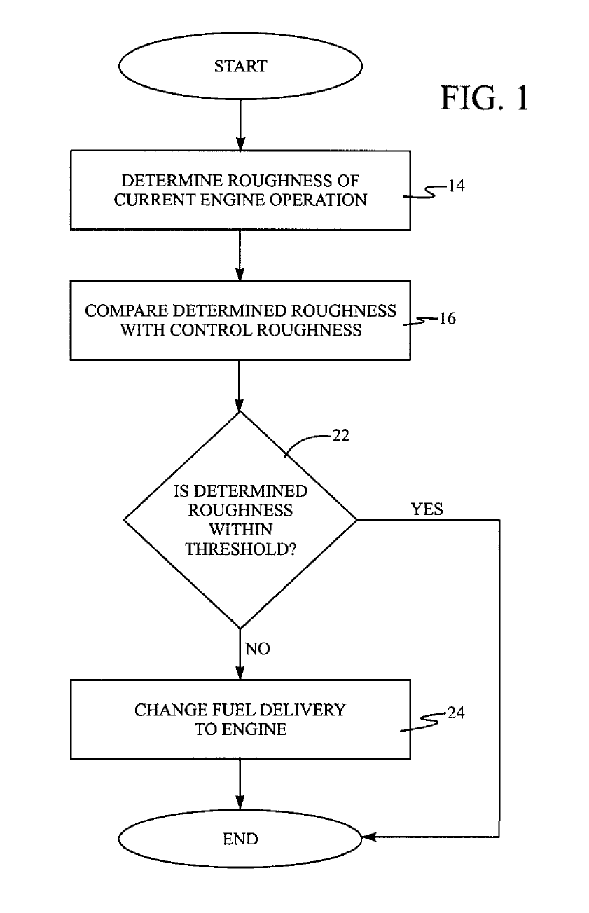

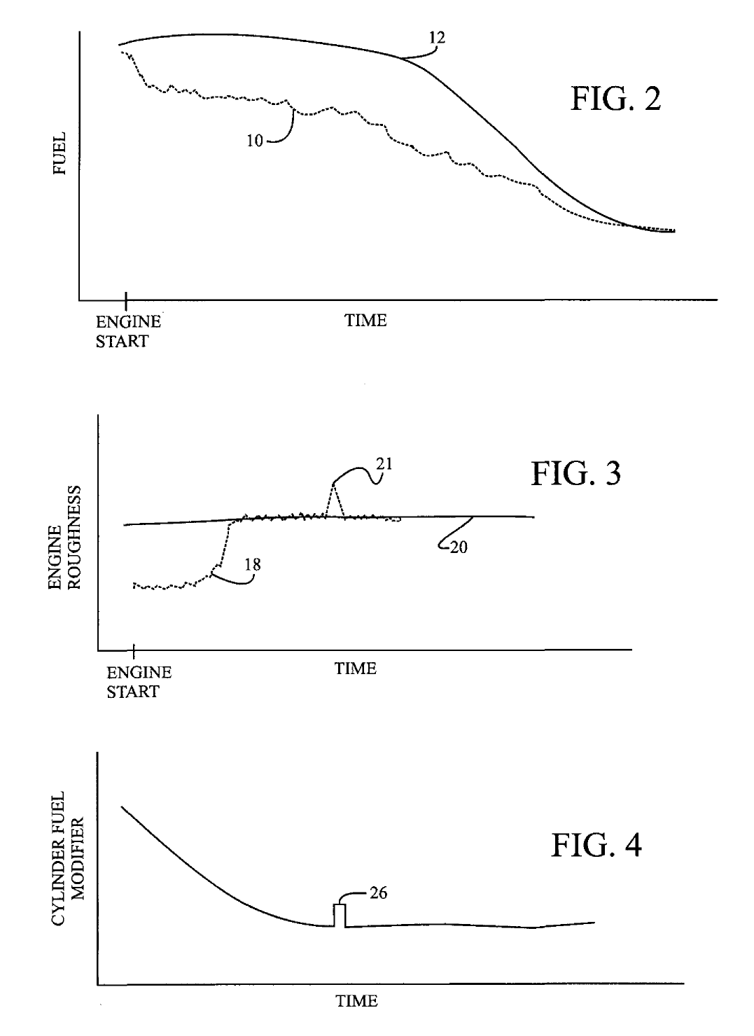

Referring in more detail to the drawings, FIG. 1 generally illustrates a process by which an engine fuel injection event can be modified as a function of current engine operation. In one presently preferred implementation, the process is employed during initial cold start of an engine, although the process may be employed otherwise during operation of the engine, including after a hot start, or otherwise as desired. Vehicles can emit a substantial amount of hydrocarbons to the atmosphere during initial engine operation. Accordingly, in at least some engines and in some engine applications, it may be desirable to provide a relatively lean fuel and air mixture into the engine cylinders for combustion. The relatively lean fuel and air mixture may contain less fuel than a stoichiometric value for combustion as shown in FIG. 2 where line 10 represents a desired lean mixture and line 12 represents a stoichiometric mixture. However, if the fuel and air mixture is too lean, the engine may not operate properly, and the hydrocarbon emissions may actually increase.

During normal engine operation, the fuel delivery may be subject to closed-loop control including feedback from one or more sensors. One such sensor may be an oxygen sensor and another may be a manifold absolute pressure (MAP) sensor. The oxygen sensor may be connected to an engine controller and adapted to sense the oxygen level in exhaust gas emitted from the engine. The MAP sensor may be communicated with an intake manifold and the engine controller and adapted to sense pressure within the manifold. Of course, other sensors may be employed to provide feedback indicative of engine operation. During initial engine operation after at least a cold start, the oxygen sensor may not be effective to provide feedback for closed-loop engine control. The oxygen sensor may not be effective to provide feedback until it has been sufficiently warmed up and, accordingly, it may not be possible to control initial engine operation, for example after a cold start, as a function of the oxygen in the engine exhaust.

Accordingly, during initial engine operation after a cold start, and otherwise as desired, an open loop control system may be employed to control fuel delivery to the engine. The fuel delivery to the engine may be controlled as a function of the roughness of the engine operation. The roughness of the engine operation may be determined in accordance with U.S. Pat. No. 5,809,969, the disclosure of which is incorporated herein by reference in its entirety. In general terms, the engine speed for a particular combustion event in an engine cylinder is compared to the engine speed from a different combustion event in a different cylinder. The difference between these values may be identified as an acceleration estimate value which may be compared with previous acceleration estimate values to provide a jerk estimate value. The jerk estimate value may be representative of a combustion metric value which is a learned value indicative of the combustion stability of the engine, and therefore, indicative of the roughness of the engine combustion and current engine operation. The average combustion metric value of current engine operation may be compared with a desired combustion metric value (which may be preprogrammed in the controller) and the difference between these values may be used to provide a modification to the rate at which fuel is delivered to the engine for subsequent combustion events. This may be done, for example, by varying a fuel injection pulse width to control the amount of fuel injected by a fuel injector into the engine.

Referring again to FIG. 1, after the roughness of current engine operation is determined at 14, that determined roughness is compared to a control engine roughness at 16 which may be predetermined and programmed in a controller, FIG. 3 illustrates a diagrammatic comparison of instantaneous engine roughness at line 18 compared to a control engine roughness at line 20 after initial engine start and over a limited time of engine operation after start. At 22 it is determined if the engine roughness is higher than the control roughness (e.g. as shown by spike or peak 21 in FIG. 3). If it is, a change to the delivery of fuel to the engine for a subsequent combustion event is implemented at 24. The change may be implemented as a function of the magnitude of the difference between the current engine roughness and the control engine roughness. The control roughness may itself provide a threshold limit above which a fuel modification event occurs, or the control roughness may be a target or desired roughness and a threshold or tolerance may be provided somewhat above the desired engine roughness. In other words, the threshold may be set so that a modification to the delivery of fuel to the engine occurs when the current engine roughness is above the control engine roughness by a certain factor or amount, for example, when the current engine roughness is greater than 5% higher than the control engine roughness. Of course, other values or ways of setting threshold may be employed, as desired for a particular application.

The change to the amount of fuel delivered to an engine cylinder for a subsequent combustion event may be made based on a number of factors. Some of those factors, without limitation, include current engine speed, and the magnitude of the difference between current engine roughness and control engine roughness. The change in the fuel delivery to the engine may be made for a single engine cylinder combustion event, or for multiple subsequent engine cylinder combustion events, as desired. It may be possible, to bring the engine roughness to, below, or within the control engine roughness, by modifying a single engine cylinder combustion event. Such a discrete change in fuel delivery is diagrammatically illustrated in FIG. 4 with a spike change 26 in fuel delivery shown for a single engine cylinder fuel delivery event. In this manner, a relatively limited and discrete change to the fuel delivery to the engine can be made to improve engine operation without significantly increasing the hydrocarbon emissions from the engine.

The change to the amount of fuel delivered to the engine may include adding more fuel than what would otherwise be added, as shown in FIG. 4, or adding less fuel than what would otherwise be added. Typically, because the fuel delivery to the engine is lean during initial engine operation, more fuel will be added to the engine by the modification of this process than what would otherwise be delivered to the engine without this modification. After an engine cylinder combustion event has been modified by way of changing the amount of fuel delivered to that engine cylinder, the process may be started over for a subsequent engine cylinder event to determine if the engine roughness is within a desired operational range or if a subsequent fuel injection event is to be modified as set fourth herein. In other words, the process may modify a single engine cylinder combustion event, and then the process may be run again to determine the engine roughness and, as a function thereof, whether a subsequent engine cylinder combustion event should be modified.

This process may be run until the closed-loop feedback control of the engine fuel delivery can be reliably accomplished. This may occur after the oxygen sensor has sufficiently warmed up, or after a preset interval of time, for example, 10, 20, 30 or 40 or more seconds. Even after starting a relatively warm engine, where the oxygen sensor may be at a sufficient temperature for its effective operation, it may take a period of time before reliable closed-loop engine feedback control can be accomplished. In this situation, the fuel can be controlled as a function of the engine roughness as set forth herein. Still further, it may be desirable in at least some applications to run the engine somewhat leaner than stoichiometric ratios, even after the engine and oxygen sensor are sufficiently warmed up. In such situations, the engine can be controlled in accordance with the process set forth herein. Of course, there may be still other situations in which a process as set forth herein may be desirable to control the fuel delivery to the engine.

While certain presently preferred implementations of a method of controlling fuel delivery to an engine have been shown and described, persons of ordinary skill in this art will recognize that the preceding disclosure has been set forth in terms of description rather than limitation, and that various modifications and substitutions can be made without departing from the spirit and scope of the invention. Methods of controlling engine operation embodying the present invention may have none, some or all of the noted features and/or advantages set forth in this disclosure. That certain features are shared among the presently preferred embodiments set forth herein should not be construed to mean that all embodiments of the present invention must have such features.

What is claimed is:

1. A method of controlling fuel delivery to a combustion engine, comprising:
determining roughness of current engine operation;
comparing the determined roughness with a control roughness to determine if the determined roughness is within a threshold limit of the control roughness;
changing the fuel delivery to the engine in a subsequent fuel delivery event as a function of the difference between the determined roughness and the control roughness at least when the determined roughness is not within said threshold limit.

2. The method of claim 1 wherein the fuel delivery is changed as a function of the difference between the determined roughness and the threshold limit.

3. The method of claim 1 wherein the fuel delivery is changed for a subsequent combustion event in the engine.

4. The method of claim 1 wherein the roughness of current engine operation is determined as a function of changes in engine speed associated with combustion in individual cylinders of the engine.

5. The method of claim 4 wherein the engine speed after a selected combustion event in one engine cylinder is compared to the engine speed after a subsequent combustion event in a different engine cylinder.

6. The method of claim 1 wherein the fuel delivery is changed for a single combustion event in an engine cylinder and the method is repeated to determine if the fuel delivery should be changed for another combustion event.

7. The method of claim 1 wherein the control roughness is equal to the threshold roughness limit so that fuel delivery to the engine is changed if the determined roughness is greater than the control roughness.

8. The method of claim 1 wherein the threshold limit for roughness is greater than the control roughness so that fuel delivery to the engine is changed when the determined roughness is greater that the threshold limit.

9. A method of controlling combustion in an internal combustion engine, comprising:
sensing engine speed for each expected firing of individual cylinders of the internal combustion engine;
determining a difference in engine speed for a selected cylinder firing and a cylinder firing occurring prior to the selected cylinder firing, said difference in engine speed providing an acceleration estimate value;
determining a difference between a current acceleration estimate value and a preceding acceleration estimate value to provide an acceleration difference value;
determining roughness of current engine operation as a function of the acceleration difference value;
comparing the determined roughness with a control roughness to determine if the determined roughness is within a threshold limit of the control roughness; and
controlling combustion of the internal combustion engine as a function of the difference between the determined roughness and the control roughness at least when the determined roughness is not within said threshold limit.

10. The method of claim 9 wherein the fuel delivery is changed as a function of the difference between the determined roughness and the threshold limit.

11. The method of claim 9 wherein the fuel delivery is changed for a subsequent combustion event in the engine.

12. The method of claim 9 wherein the fuel delivery is changed for a single combustion event in an engine cylinder and the method is repeated to determine if the fuel delivery should be changed for another combustion event.

13. The method of claim 9 wherein the control roughness is equal to the threshold roughness limit so that fuel delivery to the engine is changed if the determined roughness is greater than the control roughness.

14. The method of claim 9 wherein the threshold limit for roughness is greater than the control roughness so that fuel delivery to the engine is changed when the determined roughness is greater that the threshold limit.
